(19) United States
(12) Patent Application Publication
(10) Pub. No.: US 2009/0100984 A1
(43) Pub. Date: Apr. 23, 2009

(54) Special Resonant Side Drumhead for Live and Studio Miking Applications

(76) Inventor: William E. Ruffino, Agura Dulce, CA (US)

Correspondence Address: BERENATO, WHITE & STAVISH, LLC, 6550 ROCK SPRING DRIVE, SUITE 240, BETHESDA, MD, 20817, US

(21) Appl. No.: 12/249,693

(22) Filed: Oct. 10, 2008

Related U.S. Application Data
(60) Provisional application No. 60/981,068, filed on Oct. 18, 2007.

(51) Int. Cl. G10D 13/02

(52) U.S. Cl. 84/414

(57) ABSTRACT

The resonant drum head mounted speaker cone apparatus improves the sound of the drum on audio recordings and in live sound situations and changes the way the drum is miked in live and studio applications. By integrating the resonant side drumhead with a speaker cone, when the drum is hit (on the batter head), the air pressure generated inside the drum moves the opposite resonant head. The center of the resonant drumhead is cut out and a speaker cone with the dust cap is glued to the inside thereof facing outwards. The speaker cone, which also vibrates from this pressure, now becomes the miked surface of the instrument as opposed to previously having to mike the drum from above the respective batter heads where it often interferes with the player. Using otherwise conventional miking techniques, a wider range of attack and tone characteristics can be obtained from the drumhead. Additionally, use of optional speaker cone sizing, speaker and dust cap composition options and dust cap sound holes also contribute to define the sound characteristics based on end user preference.

This application claims the benefit of U.S. Provisional filing 60/981,068, filed Oct. 18, 2007.

### BACKGROUND OF THE INVENTION

1. Field of the Invention

The invention relates generally to a special resonant side drumhead for live and studio miking applications.

2. Background

In the past, there has been a standard way of placing microphones on a drum kit in order to get a desired sound. This mainly involves placing microphones over the batter side drumhead to pick up the attack and tone characteristics of the drum when played. Care with this placement must be taken so as to not interfere with the player and to prevent the microphones from being hit and damaged and from producing undesirable popping sounds. For the bass drum in particular, it was found that cutting a hole in the resonant side drum head was needed to allow for closer microphone placement.

With the current invention, these aspects of microphone placement change, as the drums can now be miked from the resonant side head, opposite from the player. The speaker aspect of the invention is derived from the techniques used in microphone placement on guitar and bass amplifiers, whereas the microphone is placed at the speaker cone and depending on the angle of the microphone to the speaker, either a brighter or fuller sound is picked up. Translating this to the drum, the placement of the microphone also allows for an interesting range of attack and tone, as the speaker translates the sound better than the normal resonant side drumhead which is typically never used for miking purposes.

### SUMMARY OF THE INVENTION

The present invention advantageously fills the aforementioned deficiencies by providing a special resonant side drumhead for live and studio miking applications.

The present invention relates to a special resonant side drumhead which is made up of the following required elements: (1) a drumhead, (2) a speaker cone and (3) a dust cap. These elements are connected as follows: after a cut out is made in the resonant drumhead approximately one inch in diameter smaller than the chosen size speaker, the speaker cone surround or webbing is centered in the hole and the overlap glued to the inside wall of the resonant drumhead face down with the back side of the cone sticking upwards (which will be inwardly oriented with respect to the drum when re-assembled). A dust cap is then glued to the speaker cone center.

The drumhead is re-mounted to the resonant side of the drum with the speaker cone facing outwards and tightened evenly to the drum without wrinkles. A microphone is pointed towards the speaker. When the batter side of the drum is hit, the internal air pressure generated causes the resonant side head and speaker assembly to vibrate, therefore transferring the sound of the drum to be picked up by the microphone. Several factors help to determine the attack and tone characteristics of the drum such as: a) the placement of the microphone at the speaker cone, b) different composition options available for the speaker assemblies, c) use of alternately sized speaker assemblies and d) ported sound holes in the dust cap.

Further, this invention can have one or more of the following: (1) a sound hole or port in the dust cap. It should be further noted that (a) the cone can be made of various materials, such as but not limited to polypropylene, plastics, Kevlar, Mylar, aluminum (or any other metal or metal alloy) but cardboard or polypropylene is preferable, (b) the speaker surround or webbing can be made of cardboard, coated cardboard, polyurethane, butyl rubber, foam rubber, or rubber, but cloth is preferable, (c) the dust cap can be made of various materials, such as but not limited to cardboard, coated cardboard, plastics, cloth, aluminum (or any other metal or metal alloy) but polypropylene is preferable, (d) the speaker is attached to the drumhead by various means, such as but not limited to the use of various silicone based adhesives, (e) the dust cap is attached to the speaker cone by various means, such as but not limited to the use of various silicone based adhesives.

Presently, miking a drum kit involves careful placement of the microphones near enough to the drum to pick up the sound, but not so as to get in the way of the player. There is always a compromise in placement due to the issue of the microphone getting hit while playing, causing undesirable sounds in live sound or recordings and the sound produced is only from the batter side head. Also, a resonant side drumhead is essential to the tone of the drum but is never used for miking except for the bass drum, wherein the head is either removed completely or a hole cut into it to allow closer microphone access.

This invention changes this method of miking. Firstly, the sound of the drum is picked up from the resonant side head—away from the player. Microphone placement now depends on preference, not convenience. It is known that on-axis miking will bring out a brighter attack sound, while an off-axis miking will accentuate a rounder tone.

The end user will also have options in speaker composition and size combinations to choose from, as the different speaker sizes and material compositions accentuate differences in the tonal range of the drum. Typically, using a hard material like aluminum for the speaker assembly will reproduce a brighter tone than using cardboard, which gives a more rounded tone. A larger speaker assembly will produce a deeper tone than a smaller assembly which will allow for a punchier sound. There are no other known resonant heads that offer these choices or abilities.

A standard mylar resonant head is itself a speaker, but no other resonant drum head uses an integrated speaker cone assembly as does the present invention to reproduce the drum sound wherein the drum can now be miked from the resonant side head instead of the batter side.

All other inventions try to change the sound of the drum by either muffling or removing overtones—this invention utilizes all the natural sounds of the drum because the tone that is picked up by the microphone is coming through the drum shell where the tonal characteristics are determined.

No other resonant drumhead will have as many options to customize and tune a drum's sound.

The sound principle behind this is, for any given enclosure, there is a resonant frequency or tone. Prior art which includes speaker cabinet building uses these principles. By selecting the proper size speaker for a given enclosure—certain tonal frequencies can be enhanced. This is known as “tuning”. Relating this to the drum enclosure, the drum can also be “tuned” by utilizing the size and composition options of the invention.

Sound is a relative thing—it is different to different listeners. This invention is an option available for not only drummers but also for sound engineers to achieve a particular sound from the drum that is completely new. It is also an opportunity to completely change the way drums are miked in live and studio applications that is less cumbersome for both parties. As noted previously, presently drums need to be miked from the batter side which often interferes with the player and introduces the possibilities of unwanted pops on recordings or even damage to the microphones themselves when they are accidentally hit. By miking the resonant side drum heads, there is no interference with the player and the drum sound is improved as well.

Finally, it is an object of the present invention to provide a special resonant side drumhead for live and studio miking applications that do not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 Is an exploded view of the components making up the invention

FIG. 2 Is a cross section view showing the principle behind the invention

FIG. 3 Is a perspective drawing of the invention from the front

FIG. 4 Is a perspective drawing of the invention from the back

FIG. 5 Is a plan view of a ported dust cap with variable opening control

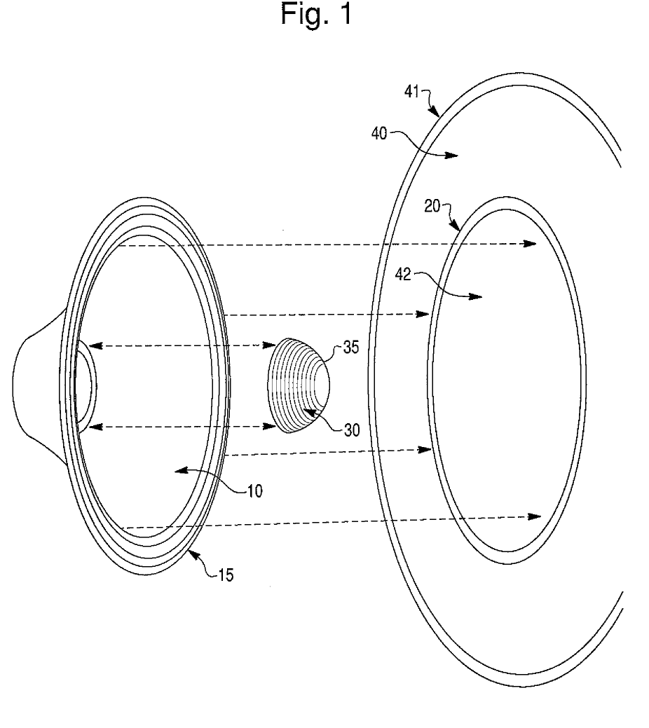

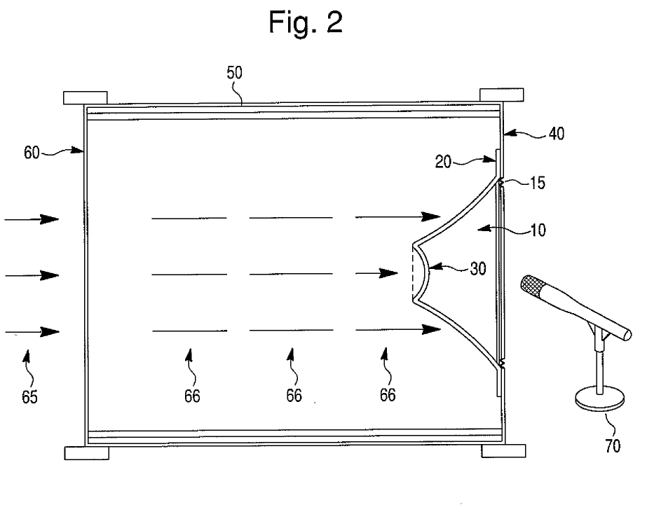

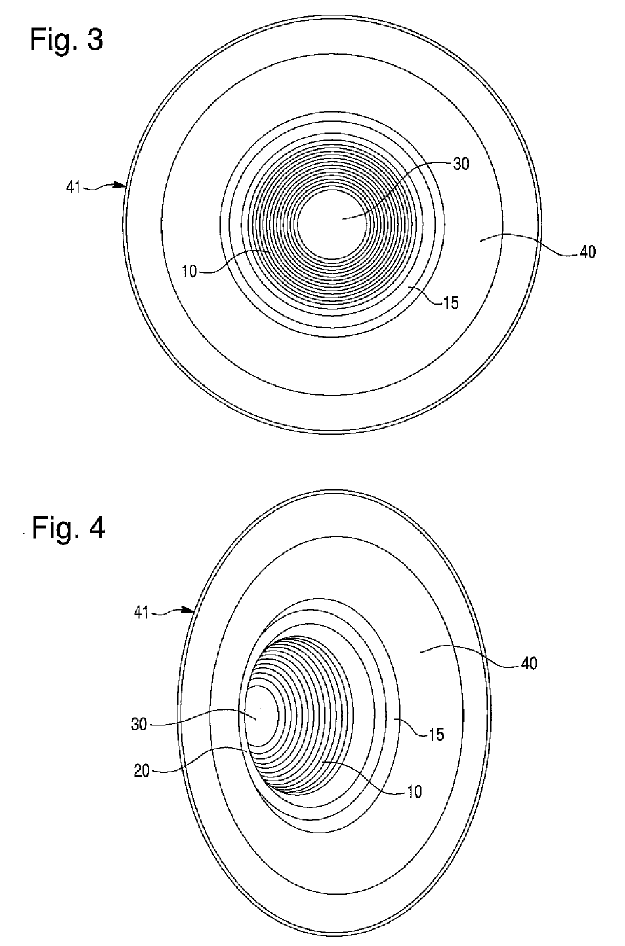

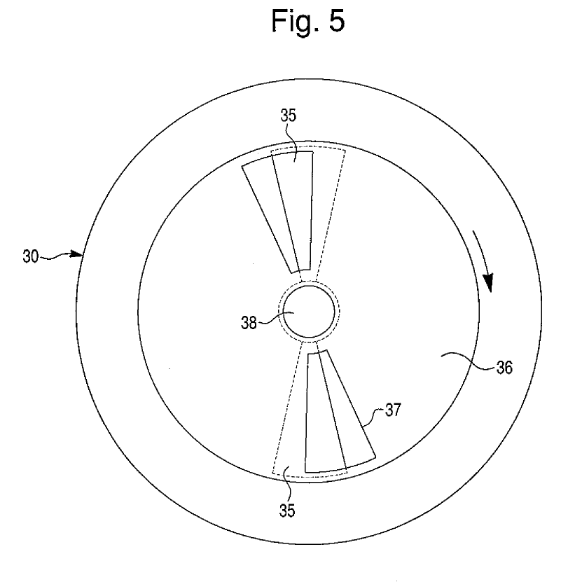

### DETAILED DESCRIPTION OF THE INVENTION

The present invention relates to a special resonant side drumhead made up of the following required elements: (1) a drumhead, (2) a speaker cone and (3) a dust cap. These elements are connected as follows (with reference to the drawing Figures): after a cut out 42 is made in the drumhead 40 approximately one inch in diameter smaller than the chosen size speaker, the speaker cone 10 surround or webbing 15 is centered in the hole and the overlap glued to the inside wall of the drumhead 40 face down with the back side of the cone 10 sticking upwards. A dust cap 30 is then glued; using a silicone based adhesive 20 to the speaker cone center to close off the central hole in the cone. Upon drying, the drum head 40 is re-assembled to the drum shell 50 using hoop 41. Furthermore, this invention may have one or more of the following: (1) a sound hole or port 35, optionally of variable/adjustable dimension (like a partially occluded set of openings on a salt/sugar dispenser, see FIG. 5), in the dust cap; (2) different material compositions of the speaker cone and dust cap, such as but not limited to polypropylene, plastics, Kevlar, Mylar, aluminum (or any other metal or metal alloy); (3) different material compositions of the speaker surround such as cardboard, coated cardboard, polyurethane, foam rubber, or rubber. The speaker is attached to the drumhead by various means, such as but not limited to the use of various silicone based adhesives. The same attachment system may be used as well for the dust cap to speaker cone interface.

When the batter side drumhead 60 is struck, the generated internal air pressure waves 65 travel through the drum where they contact the resonant side head 40 and the attached speaker cone assembly 10. The speaker surround, which is flexible, allows the speaker cone assembly to vibrate and transmit the sound exteriorly of the drum 50. The dust cap maintains the internal pressure inside the drum 50. Placement of the microphone 70 in relation to the speaker cone 10 provides for a wide range of attack and tone as it is well known that microphone placement on-axis to the speaker picks up a brighter sound, while an off-axis placement picks up a warmer sound. Based on individual preference, size and composition options of the speaker assemblies accentuate differences in the tonal range of the drum. The hole or port in the dust cap can be of a fixed (i.e., a 1″ or 2″) port diameter or of an adjustable variety to enable a closed/partially/fully open position. The port feature enables the release/maintenance of air pressure/sound wave action within the drum so as to create different sound effects from the given drum so equipped.

In FIG. 5 a dust cap 30 includes a port(s) 35 that is adjustably occluded using a centrally pinned for rotation secondary dust cap 36. Cap 36 includes ports 37 and a central control knob 38 that enables relative rotation between the dust cap 30 and cap 36. The cap 36 can be rotated, for example, to match the port(s) 35 in the underlying dust cap 30 to alter the sound and passage of sound pressure waves through the dust cap. The adjustable porting can be achieved using different structures, e.g., sliding elements, screw-in baffling, iris type with symmetric opening (i.e., like the shutter mechanism on a film based camera), etc. The basic ported dust cap (i.e., 1″ or 2″ round port) can be used with or without the adjustable porting feature. Fixed porting may be, in some instances, more advantageous and rugged and in other instances zero porting may be preferred.

An alternative embodiment of this invention eliminates the need for using glue on the resonant head speaker cone interface, although the invention is used exactly the same way. The difference is that the speaker assembly (which includes the cone, surround and dust cap) has a thin foam double sided/one-sided peel and stick gasket that is glued to the surround. The end user themselves will cut out the hole in the resonant head, then remove the peel and stick backing from the speaker assembly and affix it to the inside of the drum head and thusly attach the speaker cone surround. In this manner, the end user can utilize the invention on whatever drumhead necessary without having to seek out a drum head already so equipped. Instead, a user can locate a suitable drum of any sort and retro-fit the system as desired.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims It is indeed intended that the scope of the invention should be determined by proper interpretation and construction of the appended claims and their legal equivalents, as understood by those of skill in the art relying upon the disclosure in this specification and the attached drawings.

1. A resonant drum head, adapted for assembly onto a drum opposite a batter head thereof, comprising:
a circular resonant drum head membrane having an inwardly oriented surface and an outwardly oriented surface and having a centrally located hole therein;
speaker cone means, for transmitting vibration received against said speaker cone, said speaker cone means having an inner dust cap end and an outer forward end, said forward end being sealingly attached to an inner surface of said resonant drum head membrane and completely surrounding said hole; and,
a dust cap means for closing off said inner dust cap end of said speaker cone means, whereby, when said resonant drum head is assembled to said drum opposite said batter head, vibration and resulting sound from said batter head being struck is transmitted to said speaker cone via air pressure within said drum and is transmitted exteriorly of said drum.

2. A resonant drum head as in claim 1, wherein:
said dust cap includes a port means for controlling the release of air pressure from within said drum when said batter head is being struck thereby changing the tone of said drum.

3. A resonant drum head as in claim 2, wherein:
said port means includes a variably adjustably sized opening.

4. A resonant drum head as in claim 1, wherein:
said attachment of said forward end of said speaker cone means to said inner surface is accomplished using a silicone glue.

5. A resonant drum head as in claim 1, wherein:
said attachment of said forward end of said speaker cone means to said inner surface is accomplished using a peal and stick foam gasket there between.

6. A drum, comprising:
a drum shell having one end closed in by a batter head, and an opposite end closed in by a resonant drum head, said resonant drum head membrane having an inwardly oriented surface and an outwardly oriented surface and having a centrally located hole therein;
speaker cone means, for transmitting vibration received against said speaker cone, said speaker cone means having an inner dust cap end and an outer forward end, said forward end being sealingly attached to an inner surface of said resonant drum head membrane and completely surrounding said hole; and,
a dust cap means for closing off said inner dust cap end of said speaker cone means, whereby, vibration and sound from said batter head being struck is transmitted to said speaker cone via air pressure within said drum and passed exteriorly of said drum.

7. A drum as in claim 6, wherein:
said dust cap includes a port means for controlling the release of air pressure from within said drum when said batter head is being struck thereby changing the tone of said drum

8. A drum as in claim 7, wherein:
said port means includes a variably adjustably sized opening.
